(19) United States
(12) Patent Application Publication
(10) Pub. No.: US 2015/0179134 A1
(43) Pub. Date: Jun. 25, 2015

(54) ELECTRONIC APPARATUS AND DISPLAY METHOD THEREOF

(71) Applicant: Acer Incorporated, New Taipei City (TW)

(72) Inventor: Man-Ting Kuo, New Taipei City (TW)

(73) Assignee: Acer Incorporated, New Taipei City (TW)

(21) Appl. No.: 14/249,364

(22) Filed: Apr. 10, 2014

(30) Foreign Application Priority Data
Dec. 23, 2013 (TW) 102147826

(51) Int. Cl. G09G 5/02; G06F 3/041

(52) U.S. Cl. CPC G09G 5/02; G06F 3/0412; G09G 2340/06

(57) ABSTRACT

An electronic apparatus and a display method thereof are provided. The method is adapted to the electronic apparatus having a touch screen, and the method includes: providing a floating window above a background image of the touch screen; detecting a background color of the background image below the floating window; selecting a trajectory color according to the background color; and displaying a touch trajectory of a touch performed on the floating window according to the trajectory color.

### CROSS-REFERENCE TO RELATED APPLICATION

This application claims the priority benefit of Taiwan application serial no. 102147826, filed on Dec. 23, 2013. The entirety of the above-mentioned patent application is hereby incorporated by reference herein and made a part of this specification.

### BACKGROUND OF THE INVENTION

1. Field of the Invention

The invention relates to a display technique, and more particularly, to an electronic apparatus and a display method of displaying a touch trajectory thereof.

2. Description of Related Art

With the development of the touch screen, the method of performing writing or recording a to-do list on a touch screen with a stylus pen has gradually been accepted by the majority. In particular, by writing or recording on a touch screen with a stylus pen, in addition to lowering paper consumption, the habit of taking notes anytime and anywhere when going out or riding in a vehicle can also be more readily performed. For instance, the average electronic apparatus can all be provided with a handwriting software such that the user can perform writing, drawing, or other handwriting input functions on the canvas provided by the handwriting software. Moreover, the current handwriting software further provides a floating window floating above the screen, such that the user can perform a handwriting input function on the floating window and operate the background image below the floating window at the same time.

However, when the user executes handwriting input on the canvas or the floating window with a pen function, the user always needs to select the color of the pen provided by the pen function beforehand. Moreover, since the background color of the average floating window is rendered translucent, when the color of the background image and the color of the pen are similar, the user cannot clearly identify the trajectory of the pen movement. Therefore, the user needs to manually switch the color of the pen to replace the color of the pen with a color contrasting the background color such that the trajectory of the pen movement can be more visible. For the user, this presents considerable operational inconvenience.

### SUMMARY OF THE INVENTION

Accordingly, the invention provides an electronic apparatus and a display method thereof. The electronic apparatus and the display method thereof can automatically display a touch trajectory with a clear color according to a background image, thereby improving the operational convenience of the user.

The invention provides a display method adapted to an electronic apparatus having a touch screen. The display method includes the following steps. A floating window is provided above a background image of the touch screen. A background color of the background image below the floating window is detected. A trajectory color is selected according to the background color. A touch trajectory of a touch performed on the floating window is displayed according to the trajectory color.

The invention provides an electronic apparatus including a touch screen and a processing unit. The touch screen is used for displaying a background image. The processing unit is coupled to the touch screen. In particular, the processing unit provides a floating window above the background image of the touch screen, detects a background color of the background image below the floating window, selects a trajectory color according to the background color, and displays a touch trajectory of a touch performed on the floating window according to the trajectory color.

Based on the above, in the electronic apparatus and the display method thereof, the electronic apparatus selects a suitable trajectory color according to a background color of a background image and displays a touch trajectory of a touch performed in a floating window with the trajectory color. In this way, since the electronic apparatus can automatically display the touch trajectory in the floating window in a clear manner, the user does not need to manually switch the trajectory color of the touch trajectory when operating in the floating window. As a result, operational convenience is increased.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an electronic apparatus illustrated according to an embodiment of the invention.

FIG. 2A is a flow chart of a display method illustrated according to an embodiment of the invention.

FIG. 2B and FIG. 2C are schematic diagrams of a display method illustrated according to an embodiment of the invention.

FIG. 3 is a schematic diagram of a display method illustrated according to an embodiment of the invention.

FIG. 4A is a flow chart of a display method illustrated according to an embodiment of the invention.

FIG. 4B is a schematic diagram of a display method illustrated according to an embodiment of the invention.

### DESCRIPTION OF THE EMBODIMENTS

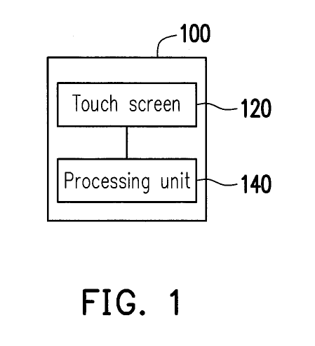

FIG. 1 is a block diagram of an electronic apparatus illustrated according to an embodiment of the invention. Referring to FIG. 1, an electronic apparatus 100 of the present embodiment is, for instance, an electronic apparatus having a touch screen such as a mobile phone, a smart phone, a personal digital assistant (PDA), a tablet computer, an EBook, or a game console. The invention does not limit the type of the electronic apparatus. The electronic apparatus 100 includes a touch screen 120 and a processing unit 140, and the functions of each thereof are as described in the following.

The touch screen 120 is a display apparatus integrating a touch detection device, and can provide a display function and an input function at the same time. The display apparatus is, for instance, a liquid crystal display (LCD), a light-emitting diode (LED) display, a field emission display (FED), or other types of displays, and the invention is not limited thereto. The touch detection device is disposed on the display apparatus, and the sensing devices are configured to receive a touch event. The touch event includes a touch performed by a finger, a palm, a body part, or other objects on the touch screen 120. The touch detection device can be, for instance, a capacitive touch detection device, a surface acoustic wave touch detection device, an electromagnetic touch detection device, a near-field imaging touch detection device, or other similar devices.

The processing unit 140 is coupled to the touch screen 120 for controlling the overall operation of the electronic apparatus 100. Specifically, the processing unit 140 of the present embodiment selects a suitable trajectory color according the background color of the touch screen 120, and thereby display the touch trajectory of a touch performed on the floating window by the user. Moreover, the processing unit 140 is, for instance, a central processing unit (CPU) or other programmable microprocessors for conventional use or specific use, a digital signal processor (DSP), a programmable controller, an application specific integrated circuit (ASIC), a programmable logic device (PLD), other similar apparatuses, or a combination of the apparatuses.

Moreover, the electronic apparatus 100 can also include a storage unit, and the storage unit is, for instance, any type of fixed or movable random access memory (RAM), read-only memory (ROM), flash memory, hard disk drive, other similar apparatuses, or a combination of the apparatuses. In the present embodiment, the storage unit is used for storing at least one application and a plurality of modules. The modules are, for instance, a computer program capable of loading the processing unit 140 to achieve the display method of the present embodiment.

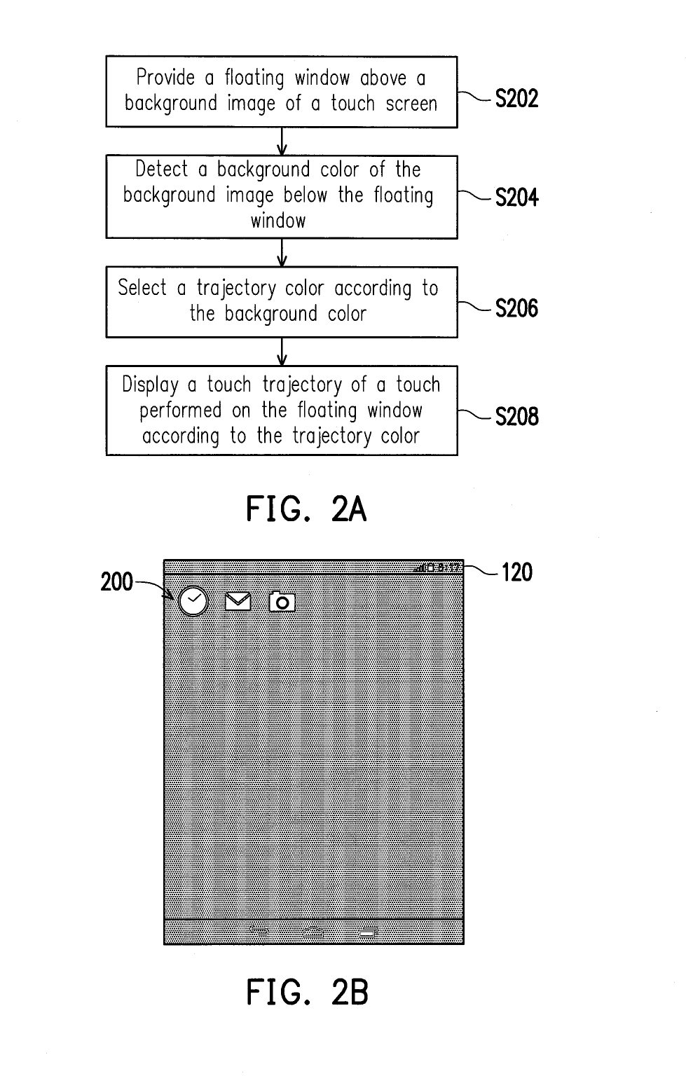

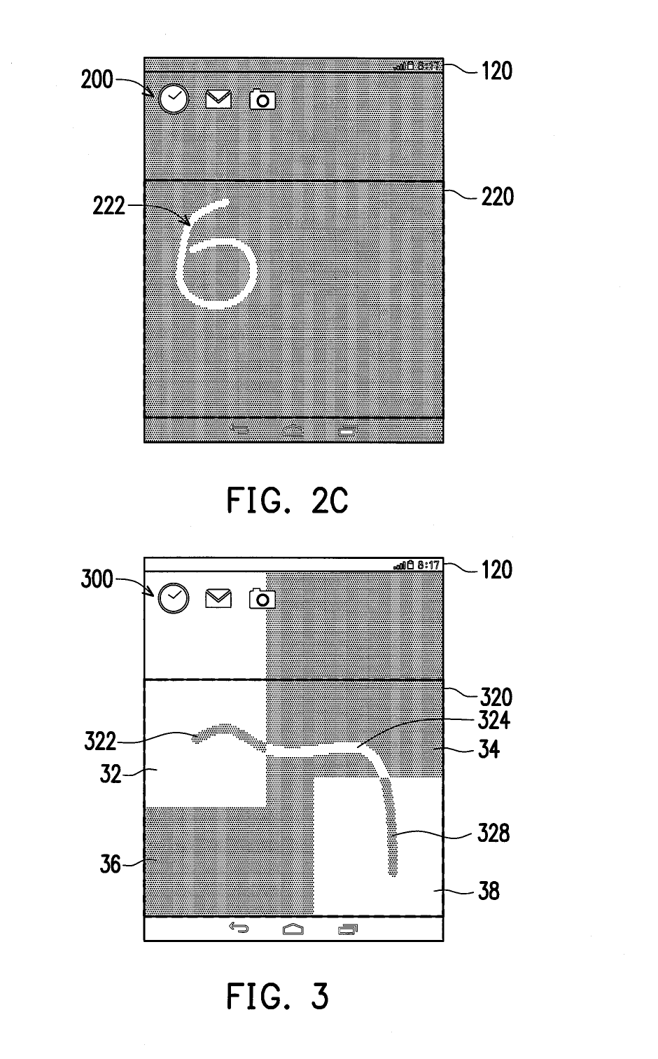

In the following, the detailed steps of the display method of the present embodiment are described with reference to the various devices in the electronic apparatus 100. FIG. 2A is a flow chart of a display method illustrated according to an embodiment of the invention. Referring to FIG. 2A, in step S202, the processing unit 140 provides a floating window above the background image of the touch screen 120, wherein the background image is, for instance, a main screen, an application interface, or other operation interfaces. Moreover, the floating window is, for instance, displayed in a translucent manner. Specifically, the electronic apparatus 100 can be installed with an application providing a handwriting input function. After the user starts the application, the processing unit 140 generates a floating window, wherein the floating window is, for instance, disposed above the background image such that the user can perform writing on the floating window. In other words, at this point, the user not only can perform an operation in the background image outside the floating window, but can also perform a touch input using the floating window at the same time to input the touch in the background image.

In step S204, the processing unit 140 detects the background color of the background image below the floating window. Here, the processing unit 140 analyzes each color value of a plurality of pixels of the background image. Each of the pixels has a color value that can be displayed by three primary colors, and can be divided into red, green, and blue sub-pixels (i.e., RGB color gamut). Moreover, each of the sub-pixels has a brightness value in a range of 0 to 255 as each of the sub-pixel values. Using black as an example, each of the brightness values of the RGB color gamut thereof is respectively R=0, G=0, and B=0; using white as an example, each of the brightness values of the RGB color gamut thereof is respectively R=255, G=255, and B=255. Therefore, by analyzing the color value of each of the pixels in the background image, the processing unit 140 can obtain information of the distribution of the color values in the background image, and can determine information such as which color values account for the most background image or account for the second most background image. It should also be mentioned that, since the user can operate in the background image to switch the background image and can perform input in the floating window with a handwriting method, when the touch of the user moves from outside the floating window to inside the floating window to perform an operation such as writing or drawing, the processing unit 140 detects the background color below the current floating window.

In step S206, the processing unit 140 selects a trajectory color according to the background color. Specifically, the processing unit 140 selects the contrasting color of the color value accounting for the most pixels as the trajectory color. In particular, the color value accounting for the most pixels, for instance, corresponds to the main background color, and the trajectory color is the contrasting color of the main background color. More specifically, the processing unit 140 can search the corresponding contrasting color in a color table to obtain the trajectory color according to the color table, wherein the color table includes the relationship of each color and contrasting color, and also according to the color value accounting for the most pixels. For instance, if the color value accounting for the most pixels is red, then the processing unit 140 can select green (i.e., the contrasting color of red) according to the color table as the trajectory color. As another example, if the color value accounting for the most pixels is yellow, then the processing unit 140 can select purple (i.e., the contrasting color of yellow) as the trajectory color.

In step S208, the processing unit 140 displays a touch trajectory of a touch performed on the floating window according to the trajectory color. Here, when the user operates the touch screen 120, the color displayed by the touch trajectory of the touch on the floating window is the contrasting color of the background color. In this way, the user can perform writing on the floating window provided by the application of the handwriting input function with the contrasting color of the background color. Accordingly, in the present embodiment, the touch trajectory can automatically be displayed by the contrasting color of the background color. As a result, not only does the user not need to manually switch or select the trajectory color, but the user can also clearly distinguish the background color from the color of the touch trajectory of the touch on the floating window.

An embodiment is described in detail below. FIG. 2B and FIG. 2C are schematic diagrams of a display method illustrated according to an embodiment of the invention. When the application used to provide the handwriting input function is not started by the processing unit 140 yet, as shown in FIG. 2B, a background image 200 in the touch screen 120 is, for instance, the main screen displaying the currently executed program or the desktop main screen of the electronic apparatus 100, but is not limited thereto. After the application used for providing the handwriting input function is started by the processing unit 140, as shown in FIG. 2C, a floating window 220 is displayed above the current background image 200 in the touch screen 120 such that the user can perform, for instance, writing or drawing on the floating window 220. At this point, the processing unit 140 detects the background color of the background image 200 below the floating window 220. If most of the background color is black (i.e., the color value of the pixels is mostly black), then the processing unit 140 selects the contrasting color of black, that is, white, as the trajectory color. In this way, a touch trajectory 222 made by the user on the floating window is displayed in white. Accordingly, the user can distinguish the white touch trajectory 222 in the floating window and not be confused by the background color (i.e., black).

It should be mentioned that, in the present embodiment, the touch trajectory of a touch on the floating window can also be displayed according to each of the color regions in the background image. Another embodiment is described below. FIG. 3 is a schematic diagram of a display method illustrated according to an embodiment of the invention. Referring to FIG. 3, the processing unit 140 provides a floating window 320 above a background image 300 of the touch screen 120 and detects the background color of the background image 300 below the floating window 320. In the present embodiment, when the processing unit 140 detects the background color, the processing unit 140 divides the background image 300 below the floating window 320 into a plurality of color regions such as color regions 32, 34, 36, and 38 to analyze each color value of a plurality of pixels in each of the color regions 32, 34, 36, and 38. More specifically, the processing unit 140 selects the color value accounting for the most pixels for the color value of the plurality of pixels in each of the color regions 32, 34, 36, and 38, and selects the contrasting color of each of the color regions 32, 34, 36, and 38 according to the color value to display the touch trajectory in each of the color regions.

For instance, if the color value accounting for the most pixels in the color region 32 is white, then the processing unit 140 displays a touch trajectory 322 in the color region 32 with the contrasting color of white, that is, black. As another example, if the color value accounting for the most pixels in the color region 34 is purple, then the processing unit 140 displays the touch trajectory 322 in the color region 34 with the contrasting color of purple, that is, yellow. In this way, when the touch of the user on the touch screen 120 moves in the floating window 320 and passes each of the color regions 32, 34, and 38, the processing unit 140 displays the touch trajectory of the touch on each of the color regions on the touch screen 120 with the contrasting color of each of the color regions 32, 34, and 38, such as touch trajectories 322, 324, and 328. In other words, when the user performs a touch operation through the floating window 320, if the touch of the user moves among the different color regions in the background image 300, then the color of the touch trajectory displayed in the floating window 320 also changes automatically according to the different color regions. Therefore, the user can intuitively and clearly distinguish the color of the touch trajectory and does not need to switch the color manually.

It should be mentioned that, in the present embodiment, the trajectory color of the touch trajectory on the floating window is not limited to the contrasting color of the background color. In other embodiments, the processing unit 140 can also select a color close to the contrasting color as the trajectory color. Another embodiment is described below.

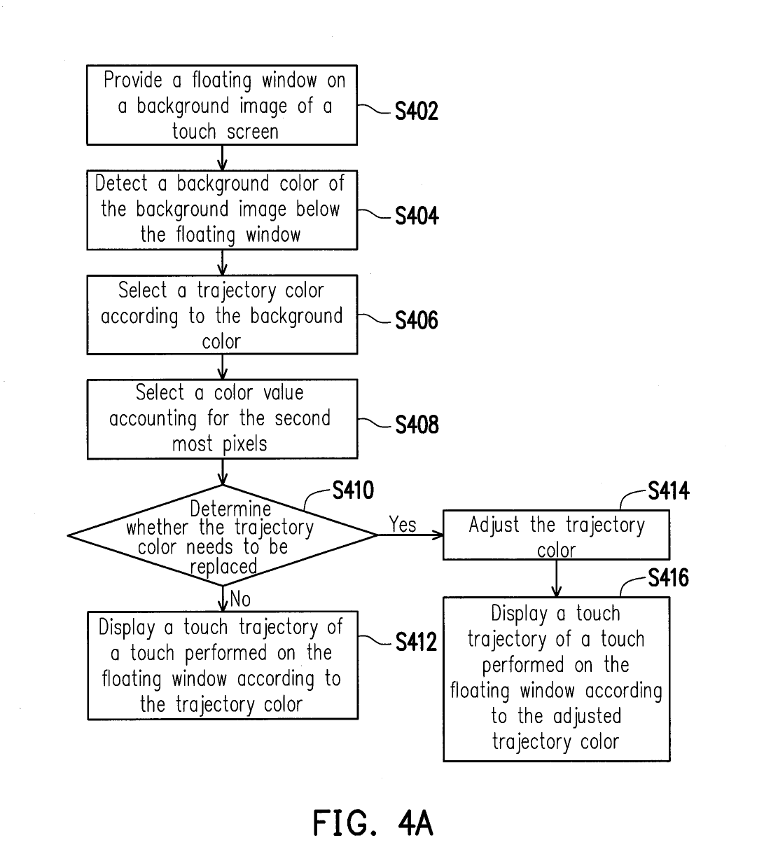

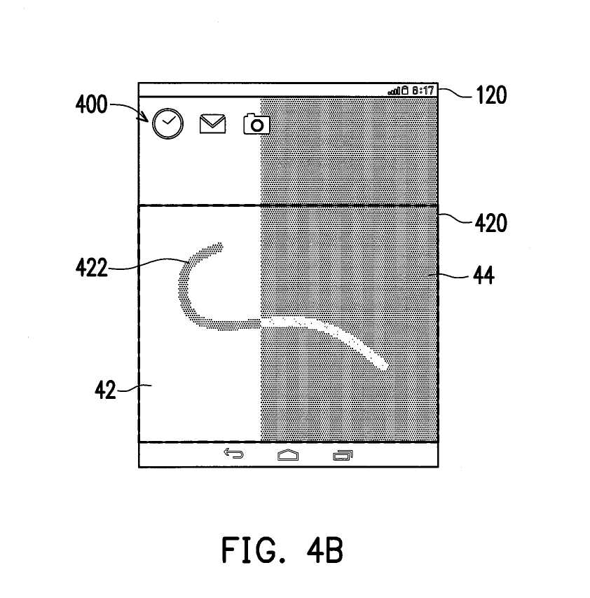

FIG. 4A is a flowchart of a display method illustrated according to an embodiment of the invention. Referring to FIG. 4A, in step S402, the processing unit 140 provides a floating window above the background image of the touch screen 120. In step S404, the processing unit 140 detects the background color of the background image below the floating window. Here, the processing unit 140 can analyze each color value of a plurality of pixels of the background image. Moreover, in step S406, the processing unit 140 selects the trajectory color according to the background color. In particular, the processing unit 140 selects the contrasting color of a first color value accounting for the most pixels of the background image as the trajectory color. In other words, the processing unit 140 uses the contrasting color of the main background color as the trajectory color.

The difference between the present embodiment and the embodiments above is that, in step S408, the processing unit 140 further selects a second color value accounting for the second most pixels. Moreover, in step S410, the processing unit 140 determines whether the trajectory color needs to the replaced. For instance, the processing unit 140 determines whether the trajectory color is close to the second color value. In particular, the processing unit 140 determines whether the trajectory color belongs to the same color range as the second color value according to, for instance, a default color range. If yes, the processing unit 140 determines the trajectory color is close to the second color value, and therefore determines the trajectory color needs to be replaced. If not, the processing unit 140 determines the trajectory color is not close to the second color value, and therefore determines the trajectory color does not need to be replaced. Accordingly, if the processing unit 140 determines the trajectory color does not need to be replaced, then as shown in step S412, the processing unit 140 displays the touch trajectory of a touch performed on the floating window according to the trajectory color.

However, if the processing unit 140 determines the trajectory color needs to be replaced, then as shown in step S414, the processing unit 140 adjusts the trajectory color. Here, since the trajectory color can include a red sub-pixel value, a green sub-pixel value, and a blue sub-pixel value, the processing unit 140, for instance, decreases at least one of the red sub-pixel value, the green sub-pixel value, and the blue sub-pixel value in the trajectory color to obtain the adjusted trajectory color. Alternatively, the processing unit 140 can also increase at least one of the red sub-pixel value, the green sub-pixel value, and the blue sub-pixel value in the trajectory color to adjust the trajectory color. Moreover, in step S416, the processing unit 140 displays the touch trajectory of a touch performed on the floating window according to the adjusted trajectory color.

FIG. 4B is a schematic diagram of a display method illustrated according to an embodiment of the invention. Referring to FIG. 4B, it is assumed that in the background color of a background image 400 below a floating window 420, the color value accounting for the most pixels thereof is black (such as most of a block 44 displays black) and the color value accounting for the second most pixels is white (such as most of a block 42 displays white). That is, the contrasting color of the block 44 is white and is the same as most of the colors of the block 42. Therefore, to let the user distinguish the color (i.e., white) of the block 42 and the trajectory color displayed by the floating window, the processing unit 140 selects a color close to the color value of white to display a touch trajectory 422 located on the blocks 42 and 44. Specifically, since in the RGB color gamut of white, the red sub-pixel value, the green sub-pixel value, and the blue sub-pixel value are all respectively 255, the processing unit 140 decreases any one brightness value in the red sub-pixel value, the green sub-pixel value, and the blue sub-pixel value to adjust the trajectory color, such that the touch trajectory 422 displayed on the floating window 420 is a light color such as “light pink” or “light orange”. In this way, when the background color is white, the trajectory operated by the user on the floating window is not also white in the block 42 such that the trajectory cannot be distinguished from the background color. Of course, in other embodiments, if the contrasting color of the block 44 is black and is the same as most of the colors (such as black) of the block 42, then the processing unit 140 increases any one brightness value in the red sub-pixel value, the green sub-pixel value, and the blue sub-pixel value in the black color, such that the touch trajectory 422 displayed on the floating window 420 is changed to a dark color such as “dark red” or “dark blue”. Therefore, in the present embodiment, the user can also intuitively distinguish the trajectory color on the floating window and the background color.

Based on the above, in the electronic apparatus and the display method thereof, the electronic apparatus can generate a floating window above a background image such that a user can perform a handwriting input function such as writing or drawing. When the user operates on the floating window, the electronic apparatus detects the background color of the background image below the floating window and selects the contrasting color of the background color or a similar color as the trajectory color, and displays the touch trajectory of a touch performed on the floating window according to the trajectory color. In this way, since the trajectory color and the background color are contrasting colors or close to being contrasting colors, the electronic apparatus can automatically display the touch trajectory in the floating window in a clear manner. Accordingly, the user does not need to manually switch the trajectory color of the touch trajectory when operating in the floating window. As a result, operational convenience is increased.

Although the invention has been described with reference to the above embodiments, it will be apparent to one of the ordinary skill in the art that modifications to the described embodiments may be made without departing from the spirit of the invention. Accordingly, the scope of the invention is defined by the attached claims not by the above detailed descriptions.

What is claimed is:

1. A display method, adapted to an electronic apparatus having a touch screen, comprising:
providing a floating window above a background image of the touch screen;
detecting a background color of the background image below the floating window;
selecting a trajectory color according to the background color; and
displaying a touch trajectory of a touch performed on the floating window according to the trajectory color.

2. The method of claim 1, further comprising:
detecting the background color below the floating window when the touch moves from outside the floating window to inside the floating window.

3. The method of claim 1, wherein the step of detecting the background color of the background image comprises:
analyzing each color value of a plurality of pixels of the background image.

4. The method of claim 3, wherein the step of selecting the trajectory color according to the background color comprises:
selecting a contrasting color of a first color value accounting for the most pixels as the trajectory color.

5. The method of claim 4, further comprising, after the step of selecting the contrasting color of the first color value accounting for the most pixels as the trajectory color:
selecting a second color value accounting for the second most pixels;
determining whether the trajectory color needs to be replaced;
adjusting the trajectory color if it is determined the trajectory color needs to be replaced; and
displaying the touch trajectory of the touch performed on the floating window according to the adjusted trajectory color.

6. The method of claim 5, wherein the trajectory color comprises a first sub-pixel value, a second sub-pixel value, and a third sub-pixel value, and the step of adjusting the trajectory color comprises:
decreasing at least one of the first sub-pixel value, the second sub-pixel value, and the third sub-pixel value in the trajectory color, or increasing at least one of the first sub-pixel value, the second sub-pixel value, and the third sub-pixel value in the trajectory color.

7. The method of claim 1, further comprising:
dividing the background color into a plurality of color regions; and
displaying the touch trajectory of the touch performed on each of the color regions on the floating window according to a contrasting color respectively corresponding to each of the color regions.

8. An electronic apparatus, comprising:
a touch screen for displaying a background image; and
a processing unit coupled to the touch screen, wherein the processing unit provides a floating window above the background image of the touch screen, detects a background color of the background image below the floating window, selects a trajectory color according to the background color, and displays a touch trajectory of a touch performed on the floating window according to the trajectory color.

9. The electronic apparatus of claim 8, wherein the processing unit detects the background color below the floating window when the touch moves from outside the floating window to inside the floating window.

10. The electronic apparatus of claim 8, wherein the processing unit analyzes each color value of a plurality of pixels of the background image to detect the background color of the background image.

11. The electronic apparatus of claim 10, wherein the processing unit selects a contrasting color of a first color value accounting for the most pixels as the trajectory color.

12. The electronic apparatus of claim 11, wherein the processing unit selects a second color value accounting for the second most pixels, determines whether the trajectory color needs to be replaced, and if it is determined the trajectory color needs to be replaced, then the processing unit adjusts the trajectory color, and displays the touch trajectory of the touch performed on the floating window according to the adjusted trajectory color.

13. The electronic apparatus of claim 12, wherein the trajectory color comprises a first sub-pixel value, a second sub-pixel value, and a third sub-pixel value, and the processing unit decreases at least one of the first sub-pixel value, the second sub-pixel value, and the third sub-pixel value in the trajectory color or increases at least one of the first sub-pixel value, the second sub-pixel value, and the third sub-pixel value in the trajectory color to adjust the trajectory color.

14. The electronic apparatus of claim 8, wherein the processing unit divides the background color into a plurality of color regions and displays the touch trajectory of the touch performed on each of the color regions on the floating window according to a contrasting color respectively corresponding to each of the color regions.
